(19) United States
(12) Patent Application Publication
(10) Pub. No.: US 2025/0137508 A1
(43) Pub. Date: May 1, 2025

(54) METHOD FOR SETTING A CLEARANCE OF A DISC BRAKE, BRAKE PAD AND SERVICE BRAKE FOR A MOTOR VEHICLE

(71) Applicant: ZF Active Safety GmbH, Koblenz (DE)

(72) Inventors: MARCO BECKER, Oberduerenbach (DE); Joerg Knieper, Vallendar (DE)

(73) Assignee: ZF Active Safety GmbH, Koblenz (DE)

(21) Appl. No.: 18/927,251

(22) Filed: Oct. 25, 2024

(30) Foreign Application Priority Data
Oct. 26, 2023 (DE) 102023129552.7

(51) Int. Cl. F16D 65/62; B60T 13/74; B60T 17/22; F16D 55/226; F16D 65/095; F16D 65/18; F16D 65/38; F16D 66/00; F16D 121/20

(52) U.S. Cl. CPC F16D 65/62; B60T 13/746; B60T 17/22; F16D 55/226; F16D 65/095; F16D 65/183; F16D 66/00; F16D 2065/386; F16D 2066/003; F16D 2066/005; F16D 2121/20

(57) ABSTRACT

Proposed is a method for setting a clearance of a disc brake for a motor vehicle, wherein the disc brake includes a brake caliper, a brake piston, a brake disc, brake pads, at least one drive unit, which is assigned to a brake pad and by which a restoring force can be applied to the assigned brake pad, and at least one sensor, which is assigned to the at least one brake pad coupled to the drive unit, wherein the method comprises determining a physical value of the brake pad, comparing the physical value with an assigned predefined limit value or a predefined limit-value range, and, if necessary the brake pad is adjusted by an assigned drive unit. Also proposed is a brake pad and a service brake for a motor vehicle.

### CROSS-REFERENCE TO RELATED APPLICATIONS

This application claims priority to German Patent Application No. 102023129552.7, filed Oct. 26, 2023, the disclosure of which is incorporated herein by reference in its entirety.

### TECHNICAL FIELD

The disclosure relates to a method for setting a clearance of a disc brake, to a brake pad and to a service brake for a motor vehicle.

### BACKGROUND

In the case of disc brakes, brake pads are usually reset following a braking operation. This is impacted, for example, by an elastic brake-piston seal being deformed during a braking operation and resuming its original shape after the brake is released. There is concomitant driving of the brake piston, which also resets the brake pad assigned to the brake piston. The brake pad is thereby separated from the brake disc, and a so-called clearance is created between the brake pad and brake disc, thus ensuring that there is no unnecessary fuel consumption or brake wear caused by dragging of the brake pads. Also common is restoration by elastic restoring elements, for example restoring arms integrated into bearing clips.

The setting of the clearance of the outer brake pad of sliding-caliper disc brakes is usually affected by springs. The restoring forces in this case must be greater on the outer side than on the inner side, as the outer brake pad has to overcome frictional forces in the housing guide and additionally has to move the entire brake caliper.

A disadvantage of known systems is that conventional restoring mechanisms using pad restoring springs achieve comparatively low restoring forces. As a result, these restoring mechanisms are not capable of reliably resetting the brake caliper over the service life of a disc brake. For example, the restoring force may no longer be sufficient when there is soiling and an associated increased friction between the pads and pad guide. With increasing soiling, the spring force may no longer be sufficient to allow the pads to reset completely.

Furthermore, if the disc is deflected when the motor vehicle is cornering, the brake caliper is displaced relative to the brake carrier. This usually cannot be compensated by pad restoring springs.

A further disadvantage is that the clearance changes over time due to abrasive wear on the brake pad and the brake disc. For example, the clearance is also subject to constant changes during operation of the motor vehicle, inter alia due to the changing temperature of the brakes.

The individual brakes of a motor vehicle may also have different clearances. Consequently, the individual brakes may have different response times and possibly also different braking forces.

### SUMMARY

On this basis, what is needed is to provide a method by which the setting of a clearance of a disc brake may be affected in a reliable and accurate manner. Furthermore, a corresponding brake pad is needed to provide reliable and accurate setting.

According to an exemplary arrangement, a method for setting a clearance of a disc brake for a motor vehicle is disclosed, the method comprising a brake caliper, a brake piston, a brake disc, brake pads, at least one drive unit, which is assigned to a brake pad and by which a restoring force can be applied to the assigned brake pad, and at least one sensor, which is assigned to the at least one brake pad coupled to the drive unit, the method comprising the following steps:
determining at least one physical value of the brake pad by at least one sensor assigned to the brake pad;
comparing the determined physical value with an assigned predefined limit value or a predefined limit-value range; and
wherein if, the at least one assigned predefined limit value is reached or undershot by the at least one determined physical value of the brake pad, or is outside of the predefined limit-value range, further comprising adjusting of the brake pad by the drive unit assigned to the brake pad in dependence on the determined physical value, and adjusting the clearance to another value other than zero.

The disc brake in one exemplary arrangement is a service brake of the vehicle.

The basic idea of the disclosure is to ascertain, due to the physical value, whether the brake pad is still in contact with the brake disc and/or what the clearance is, i.e. what is a distance between the brake pad and the brake disc.

“Determining” at least one physical value by the sensor means estimating or sensing the physical value.

Based on the above, it may be ascertained, by a comparison of the at least one physical value with the predefined limit value or the predefined limit-value range, whether a further adjustment of the brake pad is necessary or whether the brake pad is already in a position in which there is a wanted clearance.

Consequently, on the basis of the physical value it is possible to determine the positioning of the brake pad, and thus also the clearance and, if necessary, an active adjustment of the brake pad may be performed on this basis.

The predefined limit value, or the predefined limit-value range, is in one exemplary arrangement defined in such a way that there is no contact between the brake pad and brake disc, or that the clearance is as large as necessary to prevent an unwanted contact between the brake pad and brake disc in any driving situation and yet sufficiently small to realize a rapid response behaviour of the brake when it is actuated.

The terms limit value and limit-value range are also to be understood synonymously as target value and target-value range.

In one exemplary arrangement, the steps a) to c) are executed continuously by an electronic control device for as long as the determined physical value of the brake pad reaches or undershoots the predefined limit value, or is outside of the limit-value range or has reached a specified position at which there is a predefined clearance.

This continuous execution allows the brake pad to be set to a wanted position with particular precision and accuracy.

Further, the adjusting of the brake pad in step c) by the drive unit assigned to the brake pad may be impacted by the drive unit being activated in dependence on the determined physical value for a period of time derived therefrom.

This arrangement allows a particularly rapid and easy adjustment of the brake pad. Further, this arrangement also makes it possible to perform a relatively precise setting of the brake pad, since the adjustment via the drive unit is dependent on a determined physical value.

Furthermore, the physical value of the brake pad may be the pressure with which the brake pad is applied to the brake disc and/or the clearance.

If the physical value of the brake pad is the pressure with which the brake pad is applied to the brake disc, this is a particularly simple way of ascertaining whether the brake pad is still in contact with the brake disc, and therefore at least a residual frictional torque is acting upon the brake disc through the brake pad, or whether the brake disc can run freely and there is no contact between the brake pad and brake disc.

If the physical value of the brake pad is the clearance, it is thereby possible to ascertain not only whether or not there is contact between the brake pad and the brake disc, but also, in addition, how much clearance may already be present.

If the physical value is the travel distance of the brake pad, it is thereby possible to ascertain not only whether or not there is contact between the brake pad and the brake disc, but also, in addition, how much clearance may already be present, or whether the brake pad has reached a wanted specified position, or how far the axial distance of the brake pad is from a wanted specified position.

It can thereby be determined whether the clearance is too small, such that the brake pad would drag on the brake discs despite a clearance, for example during dynamic travel, or also whether the clearance is too large, which would impair the response behaviour of the brakes.

If the physical value of the brake pad relates both to the pressure with which the brake pad is applied to the brake disc and to the clearance or the axial brake-pad position, a particularly precise setting of the clearance may be affected on this basis.

There may also be a plurality of sensors provided on the brake pad, and a plurality of drive units coupled to the brake pad. Additionally, each of the drive units may be assigned to a sensor, in which case in step c) adjusting of the brake pad may be affected individually by each drive unit on the basis of the respective assigned sensor.

Thus, for example, the leading side of the brake pad could be adjusted independently of the trailing side. This is particularly advantageous if there is uneven wear on the brake pad, for example causing one region of the brake pad to still be in contact with the brake disc while a clearance has already been realised between the brake disc and another region of the brake pad.

The steps a) to c) may be applied automatically following a service-brake actuation.

This has the advantage that the respective brake pad is realigned relative to the brake disc each time, so that the wanted clearance is always present and any wear on the brake pad and brake disc is constantly taken into consideration.

A brake pad is also disclosed, comprising a pad carrier plate, a layer of friction material provided on the pad carrier plate, and at least one sensor assigned to the brake pad, the at least one sensor being a pressure sensor and/or a contactlessly operating distance sensor, and the sensor being arranged at least partially between the pad carrier plate and the layer of friction material.

The sensor is thus integrated in the brake pad itself. This has the advantage that no additional space needs to be provided for the sensor.

In addition, integration of the sensor into the brake pad makes it particularly easy to sense whether the brake pad is still being applied with pressure to the brake disc and/or whether the brake pad has a clearance in relation to the brake disc, and what this clearance is.

The brake pad may comprise at least two sensors, with one of the sensors being provided in the region of a leading side of the brake pad and the other sensor in the region of a trailing side of the brake pad.

In this way, due to the sensors arranged on different regions of the brake pad, it is thus possible to ascertain individually whether the respective region of the brake pad is in contact with the brake disc or what the clearance is between a region of the brake pad and the brake disc. This may also be used to ascertain whether there is uniform wear on the brake pad.

Furthermore, even if one sensor fails, data can continue to be sensed by the second sensor that is still functioning.

Additionally or alternatively, the brake pad may comprise at least two sensors, one of the sensors being arranged in the radially inner region relative to the brake disc and the other sensor being arranged in the radially outer region.

The advantages resulting from this arrangement are apparent from the above explanations, the advantages being enhanced if sensors are provided both on the leading side, on the trailing side, in the radially inner region and in the radially outer region of the brake pad.

Furthermore, the brake pad may have at least one coupling point at which the brake pad can be coupled to at least one drive unit, a restoring force being able to be applied to the brake pad by the at least one drive unit in the region of the at least one coupling point.

This allows a particularly simple adjustment of the brake pad.

The at least one coupling point may also be arranged in the region of the at least one sensor.

This allows corresponding physical values to be first sensed by the sensor and, in the next step, this physical value to be influenced directly, via the drive unit arranged at the respective coupling point, by adjustment of the brake pad.

In this way, each region of the brake pad where a coupling point is arranged in the region of a sensor can be set with precision.

The at least one drive unit may be an electromagnetic drive unit that has at least one coil core via which a magnetic force can be applied to the brake pad by means of a coil. The coil core in this case may form the coupling point, or may also be fastened to the coupling point.

An electromagnetic drive unit requires little space. Moreover, despite its compact structural form, it also allows high forces to be exerted upon the brake pad if necessary.

The at least one sensor may be a piezoelectric sensor.

Piezoelectric sensors are versatile and particularly robust. They are particularly suitable as a pressure sensor, but may also be used as a contactlessly operating distance sensor, for example, in the form of an ultrasonic sensor.

Position sensing of the brake pad, and thus ascertaining of the travel distance or clearance may also be affected via one or more sensors that are not integrated in the brake pad, but that may feed a physical value, as an input signal, into the electronic controller.

A service brake for a motor vehicle comprising brake pad according to the disclosure is also disclosed, the service brake further comprising an electronic control device for executing the method according to the disclosure.

The resulting advantages are apparent from the above paragraphs.

### BRIEF DESCRIPTION OF THE DRAWINGS

The disclosure is described below on the basis of an exemplary arrangement that is represented in the accompanying drawings. In these drawings:

FIG. 1 shows a perspective view of a disc brake according to a first exemplary arrangement for execution of the method according to the disclosure;

FIG. 2 shows the disc brake from FIG. 1 in a front view;

FIG. 3 shows the disc brake from FIG. 1 in a sectional view along the plane III-III;

FIG. 4 shows a schematic representation of the disc brake according to the first exemplary arrangement, in a top view;

FIG. 5 shows a schematic representation of a brake pad according to the disclosure according to a first option, in a front view;

FIG. 6 shows the brake pad from FIG. 4 in a rear view;

FIG. 7 shows a perspective view of a disc brake according to a second exemplary arrangement for execution of the method according to the disclosure;

FIG. 8 shows the disc brake from FIG. 7 in a front view;

FIG. 9 shows the disc brake from FIG. 7 in a sectional view along the plane IX-IX in FIG. 8;

FIG. 10 shows a schematic representation of the disc brake according to the second exemplary arrangement, in a top view;

FIG. 11 shows a schematic representation of a brake pad according to the disclosure according to a second exemplary arrangement, in a front view; and

FIG. 12 shows a schematic representation of a brake pad according to the disclosure according to a third exemplary arrangement, in a front view.

### DETAILED DESCRIPTION

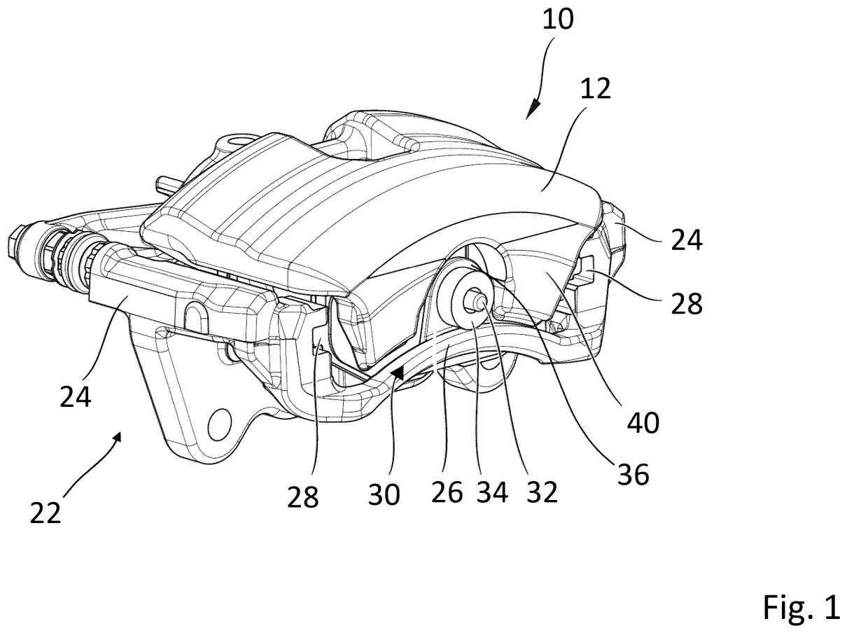

Shown in FIGS. 1 to 4 is a disc brake 10 of a service brake for a motor vehicle, according to a first exemplary arrangement.

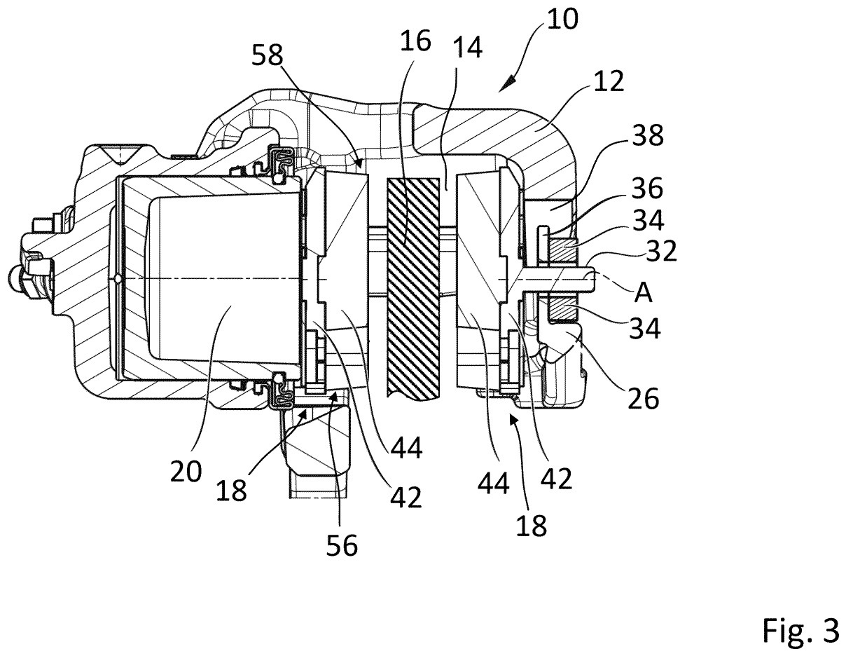

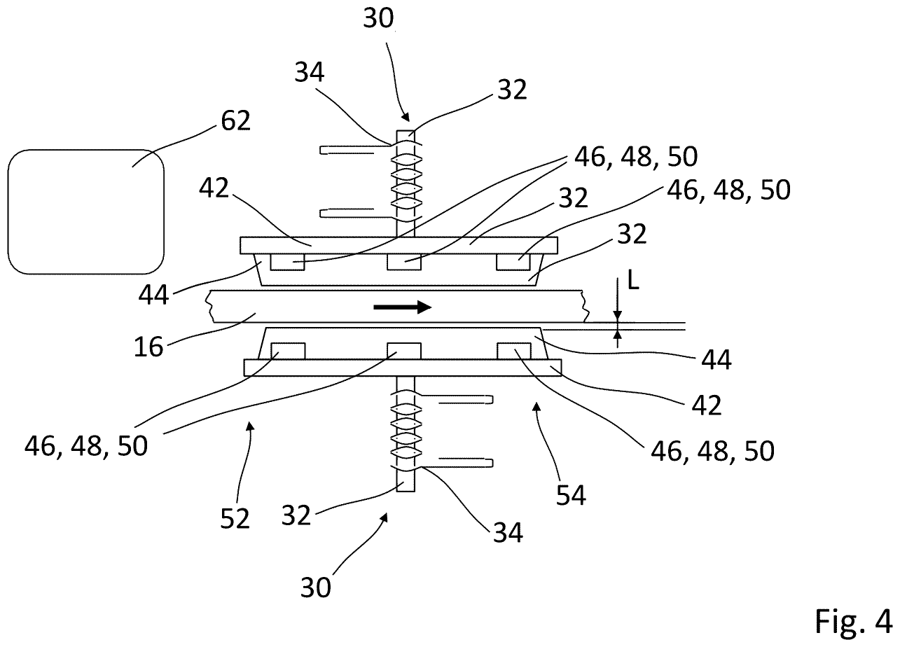

The disc brake 10 comprises a brake caliper 12 (realized here, by way of example, as a sliding caliper) with an interspace 14, in which a brake disc 16 and brake pads 18, arranged on both sides of the brake disc 16, are provided (the brake disc 16 is represented only in FIGS. 3 and 4).

The brake pads 18 can pressed against the brake disc 16 by a brake piston 20 that is linearly displaceable along an axial direction A, such that a braking force can be provided.

In addition, a brake carrier 22 is provided, on which the brake caliper 12 is movably mounted. Furthermore, the brake carrier 22 serves to interface the disc brake 10 to the vehicle.

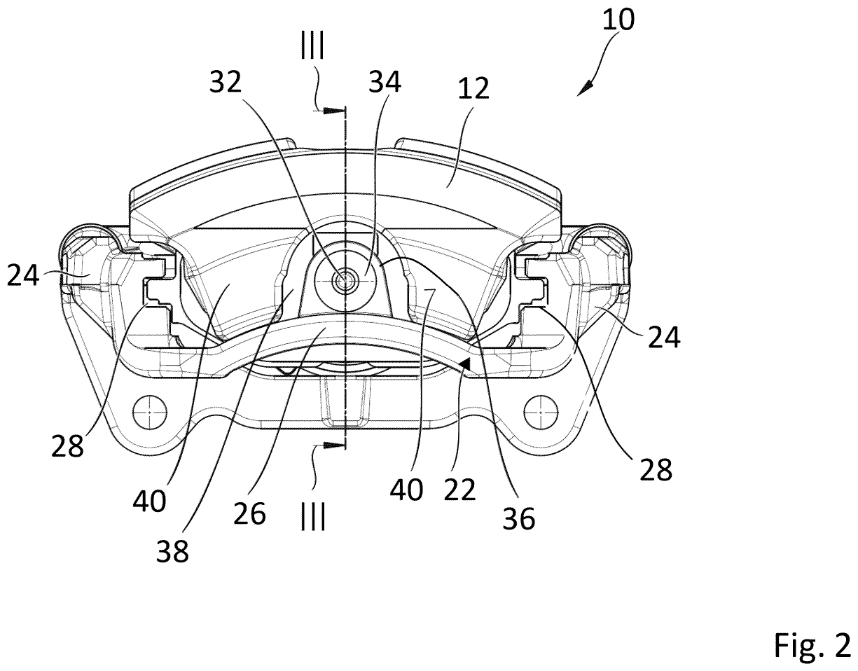

The brake carrier 22 comprises webs 24 extending in axial direction A, laterally along the brake caliper 12, and an outer structure 26, which extends along the front side of the brake caliper 12 and couples the ends of the webs 24 together (see FIG. 2).

Provided on the webs 24, on the side that faces towards the brake caliper, there are guide grooves 28, along which the brake pads 18 are guided in the axial direction A.

Further, assigned to each of the brake pads 18 is a drive unit 30, which is coupled to the respective brake pad 18. The drive unit 30 shown in FIGS. 1 to 4 is realised as an electromagnetic drive unit and can apply a magnetic force to the assigned brake pad 18.

The drive units 30 in this case serve to adjust the brake pads 18 along the axial direction A, thereby enabling, among other things, a restoring force to be applied to the assigned brake pad 18 by the respective drive unit 30. The drive units 30 are not intended to activate the service brake in order to brake the vehicle.

Alternatively, it is also conceivable for a drive unit 30 to be assigned to only one of the brake pads 18.

The drive unit 30 comprises a coil core 32 coupled to the assigned brake pad 18, and a coil 34 which is fixed on a tab 36 that extends from the outer structure 26 of the brake carrier 22 and that is arranged in a recess 38 of the brake caliper 12, the recess 38 being formed by two fingers 40 of the brake caliper 12.

In the following, the structure of the brake pads 18 will be described in more detail with reference to FIGS. 4 to 6.

Each of the brake pads 18 has a pad carrier plate 42, on which a layer of friction material 44 is provided.

In addition, there is at least one sensor 46 assigned to each of the brake pads 18, the at least one sensor 46 being a pressure sensor 48 and/or a contactlessly operating distance sensor 50. In the following, all variants for the sensor 46 are thus indicated by use of the reference designations 46, 48, 50.

Further, the sensor 46 may be realised as a piezoelectric sensor.

The sensor 46 allows a clearance L to be sensed (see FIG. 4 for example). If the sensor 46 is a contactlessly operating distance sensor 50, the clearance L can be measured.

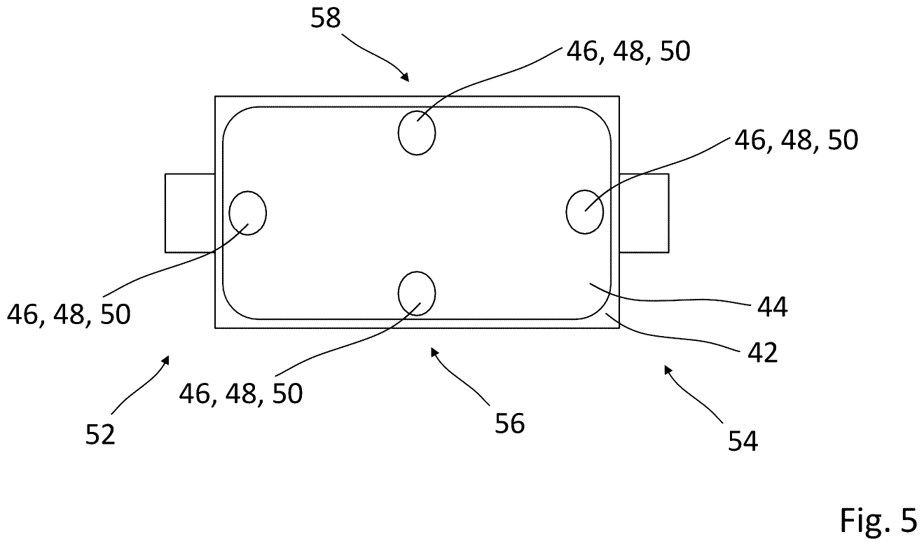

The at least one sensor 46 in this case is arranged between the pad carrier plate 42 and the layer of friction material 44 of the brake pads 18 (see, e.g., FIG. 5).

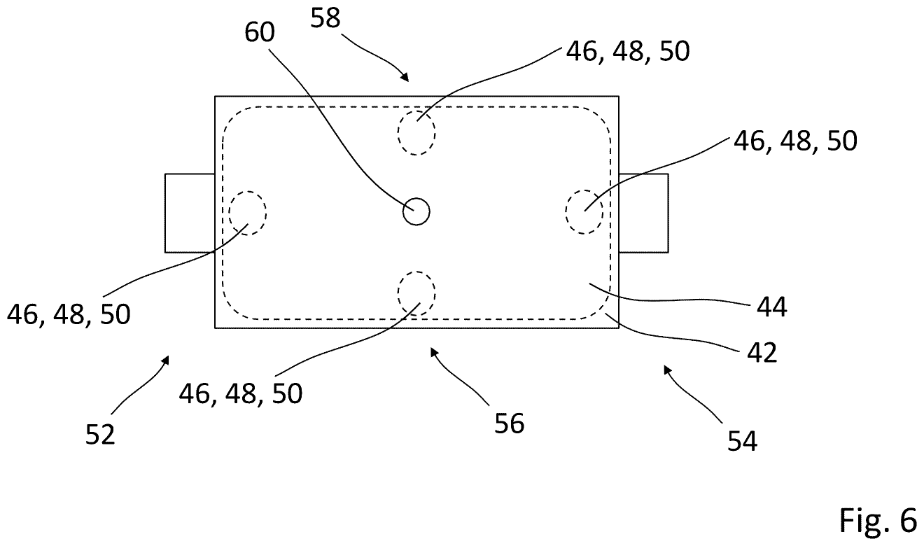

As can be seen from FIG. 5 and FIG. 6, the brake pad 18 may also have a plurality of sensors 46, 48, 50.

Accordingly, on both brake pads 18 there is a sensor 46, 48, 50 arranged in each case in the region of a leading side 52 and a further sensor 46, 48, 50 arranged in the region of a trailing side 54.

Further, there a sensor 46, 48, 50 arranged in a, relative to the brake disc 16, radially inner region 56, and additionally a sensor 46, 48, 50 arranged in a radially outer region 58.

Alternatively, there may be more or fewer than four sensors provided in the brake pad.

In addition, provided on the brake pads 18 there is a coupling point 60, at which the drive unit 30 can be coupled to the brake pad 18, to enable a restoring force to be applied to the brake pad 18 (see, e.g., FIG. 4).

In addition, an electronic control device 62 is provided, which is electrically coupled to the sensors 46, 48, 50 and the drive units 30.

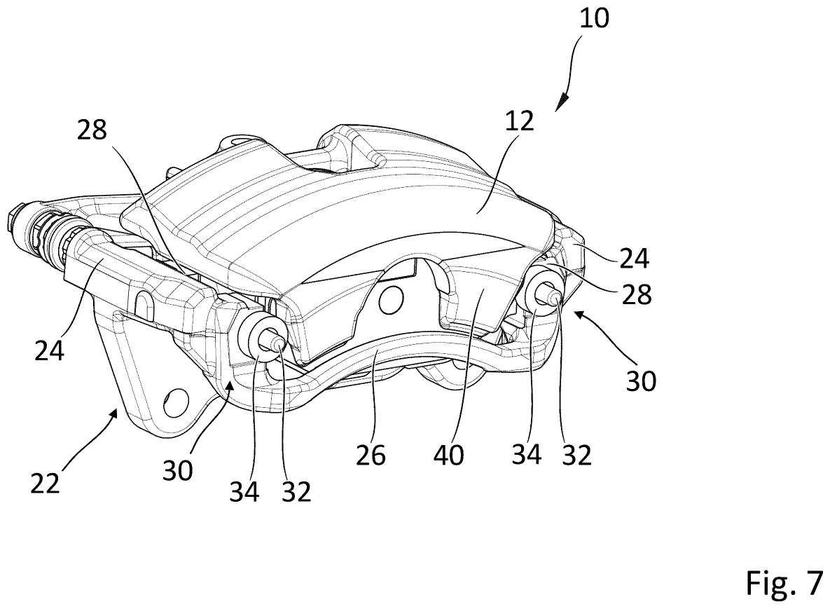

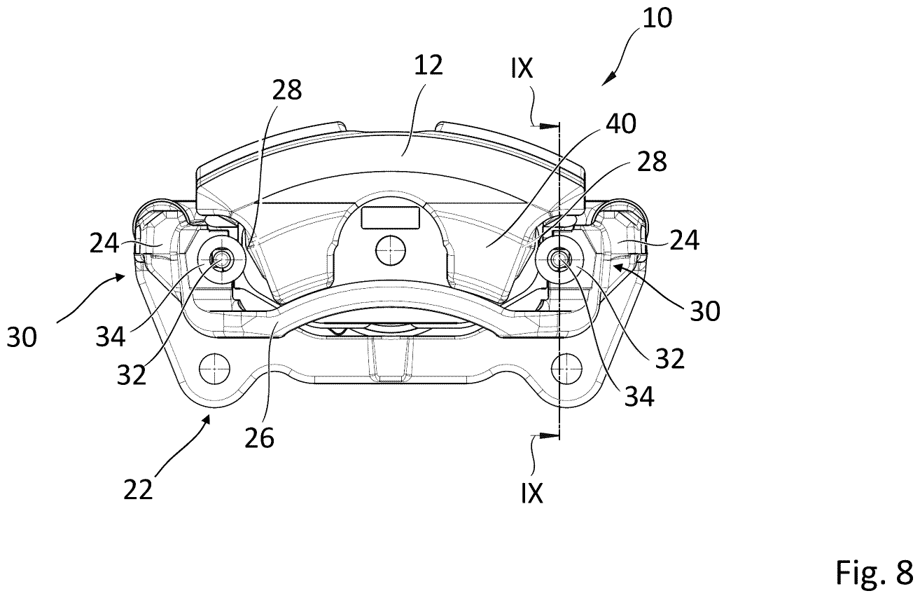

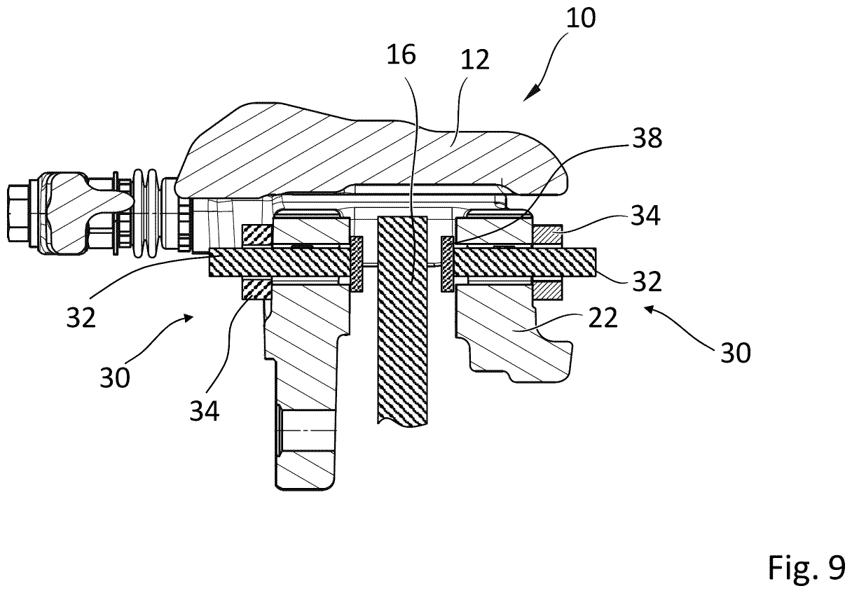

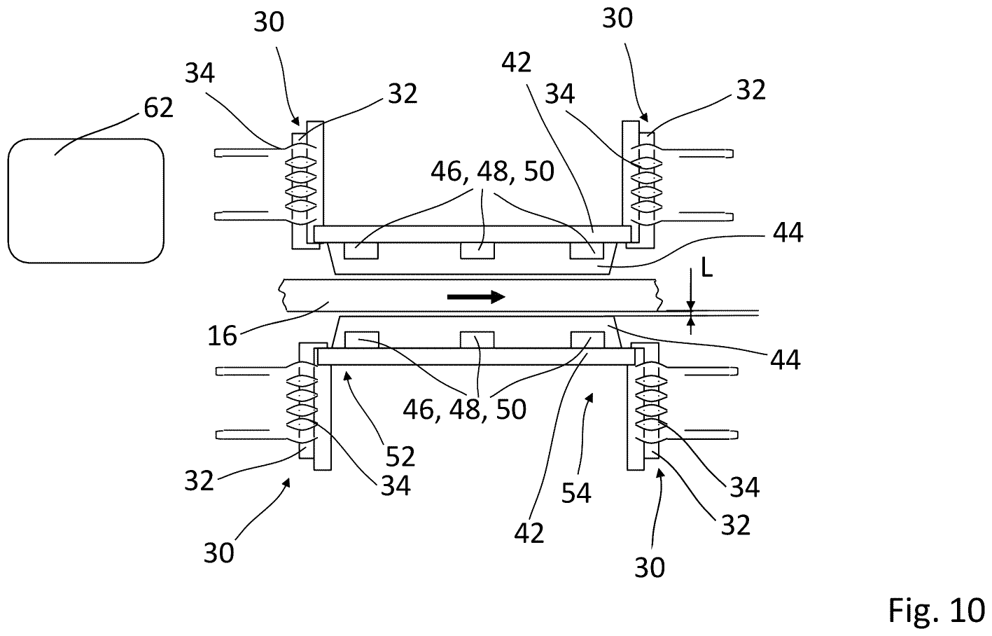

FIGS. 7 to 11 show a disc brake 10 according to a second exemplary arrangement.

In contrast to the disc brake 10 shown in FIGS. 1 to 6, the disc brake 10 according to the second exemplary arrangement has two drive units 30 per brake pad, which are provided in the region of the webs 24 of the brake carrier 22.

The coils 34 in this case are each provided on the brake carrier 22, while the coil cores 32 are provided in the region of the leading side 52 and the trailing side 54 of the brake pads 18.

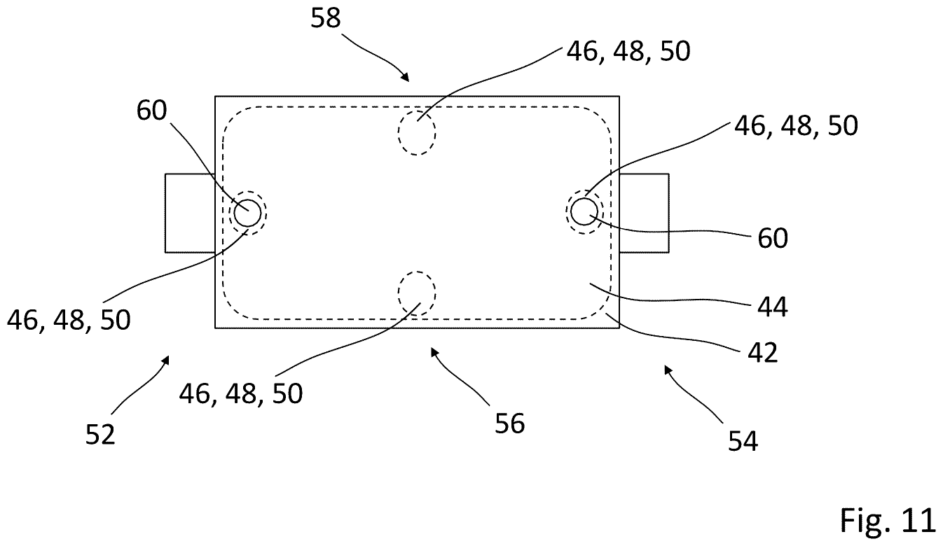

Accordingly, according to a second option, the brake pad 18 shown in FIG. 11 also has two coupling points 60, the coil cores 32 being joined to the coupling points 60.

In addition, the coupling points 60 are arranged in the region of the sensors 46, 48, 50, such that in each case there is a drive unit 30 assigned to the sensors 46, 48, 50 in the region of the leading side 52 and the trailing side 54.

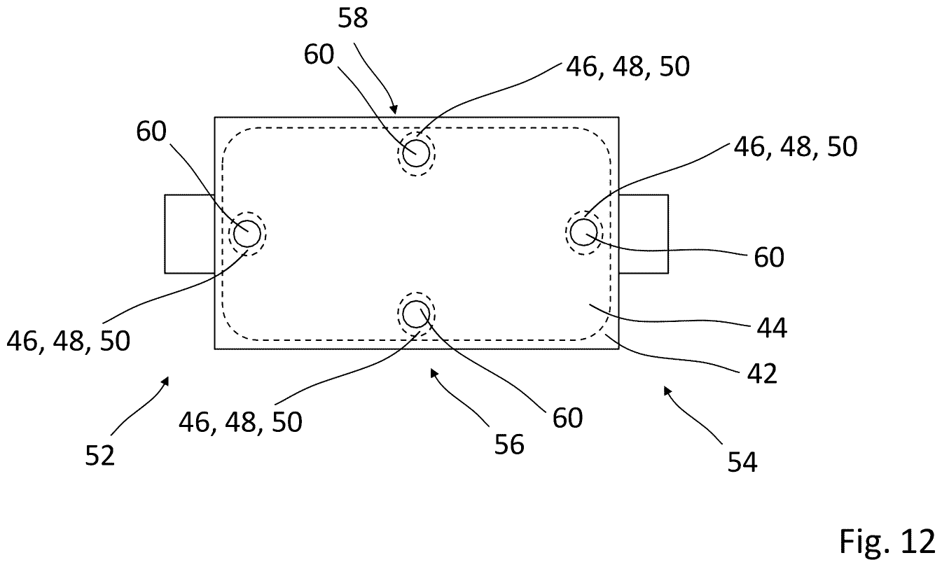

FIG. 12 shows a brake pad 18 according to a third option. In this option, the brake pad 18 has four coupling points 60, such that there is a drive unit assigned to each sensor 46, 48, 50.

A method for setting the clearance L of the disc brake 10 is explained below. The method may be executed for both brake pads 18 or, also, just for a single brake pad 18.

In the first step of the method, a physical value of the respective brake pad 18 is determined. This is accomplished via the sensors 46, 48, 50 assigned to the brake pad 18.

The physical value in this case is, for example, the pressure with which the brake pad 18 is applied to the brake disc 16. Accordingly, the sensor 46 is a pressure sensor 48 (for example, a piezoelectric sensor).

Additionally or alternatively, the physical value may also be the clearance L between brake pad 18 and brake disc 16, such that the sensor 46 is additionally or alternatively realised as a contactlessly operating distance sensor 50.

In the next step, the determined physical value is compared with an assigned predefined limit value or a predefined limit-value range.

If the physical value is the pressure with which the brake pad 18 is applied against the brake disc 16, it is advisable for the predefined limit value or limit-value range to be selected in such a way that no residual torque (for example due to a dragging brake pad 18) acts upon the brake disc 16, or in such a way that this braking torque is negligibly small.

If the physical value additionally or alternatively corresponds to the clearance L between brake pad 18 and brake disc 16, the predefined limit value or the predefined limit-value range may be selected in such a way that an optimum brake response behaviour can be achieved despite the clearance, and that there is no contact between the brake disc 16 and the brake pads 18 even during dynamic travel.

If a plurality of sensors 46, 48, 50 are provided, each of the physical values determined by the sensors 46, 48, 50 is compared with a predefined limit value or a predefined limit-value range.

If the assigned limit value is reached or exceeded by the determined physical value of the brake pad 18 or if it is outside of the predefined limit value range, the respective brake pad 18 is adjusted by the at least one drive unit 30.

The adjustment by the drive unit 30 is effected in dependence on the determined physical value, with the clearance L being set to at least one other value other than zero.

The determining of the physical value and the comparison of the determined physical value with an assigned limit value or a limit-value range is effected continuously by the electronic control device 62 for as long as the determined physical value of the brake pad 18 reaches or undershoots the predefined limit value or is outside of the predefined limit-value range, or until the brake pad 18 has reached a predefined specified position at which there is a predefined clearance L.

Alternatively, the adjusting of the brake pad 18 by the assigned drive unit 30 may also be effected by the drive unit 30 being activated in dependence on the determined physical value for a period of time derived therefrom.

If, in the comparison of the physical value with the assigned predefined limit value or the predefined limit-value range, the deviation is particularly large, the drive unit 30 is activated for a longer period of time than if there is only a small deviation.

In the case of the disc brake 10 according to the second exemplary arrangement, in step c) the adjustment of the brake pad 18 may be affected individually by each drive unit 30 on the basis of the physical value determined by the respective assigned sensor 46, 48, 50.

Thus if, for example, only one of the determined physical values of the brake pad 18 reaches or exceeds the predefined limit value or is outside the limit-value range, the brake pad 18 is also only adjusted by the drive unit 30 assigned to the respective sensor 46, 48, 50.

The method may be also be affected automatically following a service-brake actuation.

Alternatively, it is also possible for the method to be implemented only following a service-brake actuation in which a certain threshold value suitable for characterising the intensity of a service brake has been exceeded.

1. A method for setting a clearance of a disc brake for a motor vehicle, wherein the disk brake includes a brake caliper, a brake piston, a brake disc, brake pads, at least one drive unit, which is assigned to a brake pad and by which a restoring force can be applied to the assigned brake pad, and at least one sensor, which is assigned to the at least one brake pad coupled to the drive unit, wherein the method comprises the following steps:
a) determining at least one physical value of the brake pad by operation of the at least one sensor assigned to the brake pad;
b) comparing the determined physical value with an assigned predefined limit value or a predefined limit-value range; and
c) wherein when the at least one assigned predefined limit value is reached or undershot by the at least one determined physical value of the brake pad, or is outside of the predefined limit-value range, adjusting of the brake pad by the drive unit assigned to the brake pad depending on the determined physical value, and adjusting the clearance to another value other than zero.

2. The method according to claim 1, wherein the steps a) to c) are executed continuously by an electronic control device for as long as the determined physical value of the brake pad reaches or undershoots the assigned predefined limit value, or is outside of the predefined limit-value range or has reached a specified position at which there is a predefined clearance.

3. The method according to claim 1, wherein the adjusting of the brake pad in step c) by the drive unit assigned to the brake pad is impacted by the drive unit being activated depending on the determined physical value for a period of time derived therefrom.

4. The method according to claim 1, wherein the physical value of the brake pad is the pressure with which the brake pad is applied to the brake disc and/or the clearance and/or the travel distance of the brake pad.

5. The method according to claim 1, wherein there are a plurality of sensors provided on the brake pad, and a plurality of drive units coupled to the brake pad, and that each of the drive units is assigned to a sensor, in which case in step c) the adjusting of the brake pad is impacted individually by each drive unit based on the respective assigned sensor.

6. The method according to claim 1, wherein steps a) to c) are implemented automatically following a service-brake actuation.

7. A brake pad comprising a pad carrier plate, a layer of friction material provided on the pad carrier plate, and at least one sensor assigned to the brake pad, the at least one sensor being a pressure sensor and/or a contactlessly operating distance sensor, and the sensor being arranged at least partially between the pad carrier plate and the layer of friction material.

8. The brake pad according to claim 7, wherein the brake pad comprises at least two sensors, with one of the sensors being provided in a region of a leading side of the brake pad and the other sensor in a region of a trailing side of the brake pad.

9. The brake pad according to claim 7, wherein the brake pad comprises at least two sensors, wherein one of the sensors is arranged in a radially inner region relative to the brake disc and the other sensor being arranged in a radially outer region.

10. The brake pad according to claim 7, wherein the brake pad has at least one coupling point at which the brake pad can be coupled to at least one drive unit, a restoring force being able to be applied to the brake pad by the at least one drive unit in a region of the at least one coupling point.

11. The brake pad according to claim 10, wherein the at least one coupling point is arranged in a region of the at least one sensor.

12. The brake pad according to claim 10, the at least one drive unit is an electromagnetic drive unit that has at least one coil core via which a magnetic force can be applied to the brake pad by a coil.

13. The brake pad according to claim 7, wherein the at least one sensor is a piezoelectric sensor.

14. A service brake for a motor vehicle, comprising a brake pad according to claim 7, and comprising an electronic control device for adjusting the brake pad executing the method according to any one of claims 1 to 6.
